(19) United States
(12) Patent Application Publication
(10) Pub. No.: US 2008/0150463 A1
(43) Pub. Date: Jun. 26, 2008

(54) WINDSHIELD WIPER CONTROL APPARATUS

(76) Inventor: John G. Posa, Ann Arbor, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/613,710

(22) Filed: Dec. 20, 2006

(51) Int. Cl. H02P 1/04; H02P 3/00

(52) U.S. Cl. 318/483

(57) ABSTRACT

Windshield wiper control apparatus comprises one or more door-open sensors and electronic control circuitry operative to terminate or slow down the operation of the windshield wipers if the door associated with that sensor is opened. The apparatus may further include an inclement weather detector, such that the electronic control circuitry is only operative to terminate or slow down the operation of the windshield wipers if inclement weather is detected. The apparatus may further include a vehicle movement sensor, such that the electronic control circuitry is only operative to terminate or slow down the operation of the windshield wipers if the vehicle is not moving.

### FIELD OF THE INVENTION

This invention relates generally to vehicular control and, in particular, to windshield wiper control apparatus.

### BACKGROUND OF THE INVENTION

In many vehicles 102 (FIG. 1), particularly sport-utility vehicles having large armrests, when an operator or passenger opens their door during rain or snow, it is not uncommon for water or snow to be thrown 110 onto the armrest 112 and other interior panels when the door 100 is open and the windshield wipers 104, 106 are in operation. Not only does this require maintenance, if sufficient water leaks through to the electrical contacts of switches located on the armrest or elsewhere, reliability problems may arise.

### SUMMARY OF THE INVENTION

This invention resides in windshield wiper control apparatus. The preferred embodiment comprises one or more door-open sensors and electronic control circuitry operative to terminate or slow down the operation of the windshield wipers if the door associated with that sensor is opened. The apparatus may further include an inclement weather detector, such that the electronic control circuitry is only operative to terminate or slow down the operation of the windshield wipers if inclement weather is detected. The apparatus may further include a vehicle movement sensor, such that the electronic control circuitry is only operative to terminate or slow down the operation of the windshield wipers if the vehicle is not moving.

### BRIEF DESCRIPTION OF THE DRAWINGS

FIG. 1 is a drawing that illustrates problems associated with existing windshield wiper control systems; and

FIG. 2 is a block diagram illustrating the preferred embodiment of the invention.

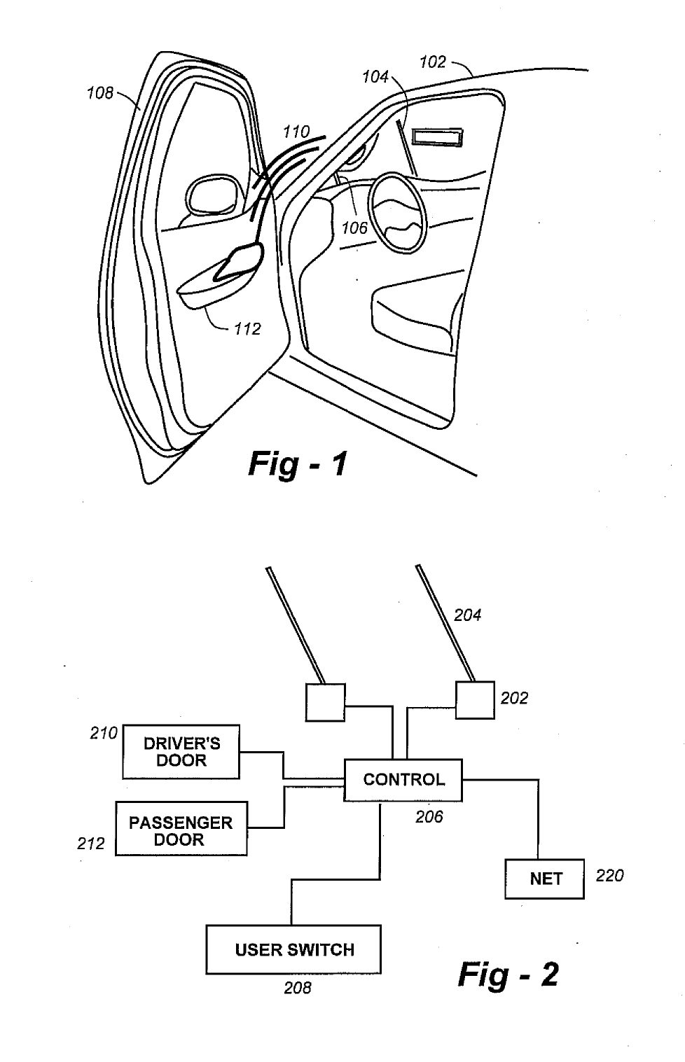

### DETAILED DESCRIPTION OF THE INVENTION

This invention broadly resides in electrical circuitry that either turns off or slows down the wipers when the driver side door is opened. The invention may also work when the passenger door is opened as well. A block diagram of the preferred embodiment is depicted in FIG. 2. Wiper motors 202 drive wipers 204 in response to some form of controller or relay switch 206. The controller or relay switch 206 is activated by a user switch 208, now commonly found on the steering column. The controller 206 may be connected to a vehicle network 220. The items just described may already be present in the vehicle, and the invention is also compatible with intermittent wiper configurations.

The invention includes the addition of one or more door a-jar detectors 210, 212, interconnected to the wiper control unit 206. When the driver door detector 210, for example, indicates that the door is open, the controller either terminates operation of the wipers, or slows them down to avoid dumping water or snow into the vehicle when the door is a-jar. As discussed, sensors for other doors, including the passenger side-door or back doors, hatch doors, and so forth, may also be accommodated. If the vehicle is equipped with some form of inclement weather detector, that, too, may be integrated into the system, such that the wipers need not be terminated or slowed down if it is not raining or snowing.

The invention should be straightforward to implement, since most if not all vehicles already have door a-jar sensors. However, currently, these sensors are used only to turn on dome lights and indicator lamps on the dashboard, and are not integrated into the windshield wiper control unit. Rewiring and programming for the intended purpose of the invention should be relatively easy to implement. The operation is also safe, since, if the vehicle is stopped, turning off or slowing down the wipers should not present a safety issue. Even if the vehicle is moving, the only reason to open the doors is to shut them properly, in which case a slight termination of normal windshield wiper operation is acceptable. As an option, a vehicle movement sensor may be integrated into the system, such that the wipers are not terminated or slowed down if the vehicle is moving and the doors are opened or ajar.

I claim:

1. A windshield wiper control apparatus comprising:
one or more door open sensors; and
electronic control circuitry operative to terminate or slow down the operation of the windshield wipers if the door associated with that sensor is opened.

2. The apparatus of claim 1, further including:
an inclement weather detector; and
wherein the electronic control circuitry is only operative to terminate or slow down the operation of the windshield wipers if inclement weather is detected.

3. The apparatus of claim 1, further including:
a vehicle movement sensor; and
wherein the electronic control circuitry is only operative to terminate or slow down the operation of the windshield wipers if the vehicle is not moving.
